(19) United States
(12) Patent Application Publication
(10) Pub. No.: US 2013/0015817 A1
(43) Pub. Date: Jan. 17, 2013

(54) CHARGE AND DISCHARGE BALANCING CIRCUIT FOR STORAGE BATTERY SET

(71) Applicants: Lian WANG, Taipei (TW); Tar Li HSIEH, Yangmei City (TW)

(72) Inventors: Lian WANG, Taipei (TW); Tar Li HSIEH, Yangmei City (TW)

(73) Assignee: ULTRACAP TECHNOLOGIES CORP., Hsinchu (TW)

(21) Appl. No.: 13/545,686

(22) Filed: Jul. 10, 2012

(30) Foreign Application Priority Data
Jul. 12, 2011 (TW) 100124539

(51) Int. Cl. H02J 7/00

(52) U.S. Cl. 320/118

(57) ABSTRACT

A charge and discharge balancing circuit for a storage battery set, the set comprising n storage batteries connected in series, the circuit comprising: a switch set constituted of n switches, each switch having a first and a second switching nodes and a common node, the second switching node of a previous switch and the first switching node of a next switch being electrically connected, and the first switching node and the second switching node of each switch being connected in parallel to both terminals of the storage battery in order; an electricity storage component set constituted of n−1 electricity storage components connected in series, both terminals of each electricity storage component being connected in parallel to the common nodes of two switches in order; and a pulse generator for controlling the switching of the common node of each switch between the first and the second switching node at a frequency.

### FIELD OF THE INVENTION

The present invention relates to a charge and discharge balancing circuit, and in particular, a charge and discharge balancing circuit for a storage battery set.

### BACKGROUND OF THE INVENTION

The voltage and capacity of a single storage battery (such as NiMH battery, lead-acid battery, lithium battery, etc.) are limited, and therefore a storage battery set constituted of storage batteries connected in series is required for use in many electric appliances. However, the electrical characteristics (such as voltage, current, capacity (ampere-hour), etc.) of each storage battery of the storage battery set are slightly different from one another, and therefore each of the storage batteries connected in series cannot provide the same output voltage and current, which causes a power supply balancing issue among each storage battery. Also, as the electrical characteristics of each storage battery are different from one another, the cycle life will also be different from one another after many times of charge and discharge; however, the cycle life of the whole storage battery set is depending on the storage battery whose cycle life is shortest.

In order to extend the cycle life of the storage battery set, there are lossless and balanced charge and discharge methods proposed to be applied to each storage battery of the storage battery set, which currently include the following methods.

A method is to provide a balancing circuit connected in parallel to each storage battery of the storage battery set so as to divide the current. When a storage battery comes to a complete charge first, the balancing circuit can avoid this storage battery from being overcharged by converting the surplus energy into thermal energy, and the other storage batteries that have not been completely charged are continuously charged. The balancing circuit of this method is simple but will cause too much loss of energy, and therefore is not adapted to a quick charge system for the storage battery.

Another method is that each storage battery is discharged to a load one by one to the same level before the storage battery set is charged, and then is charged with a constant current to ensure an accurate balancing state among each storage battery. However, for the storage battery set, as each storage battery has different electrical characteristics from one another, the discharge of each storage battery is difficult to achieve an ideal consistence effect. Even if the discharge can achieve a consistence effect, there will also be a new unbalancing phenomenon occurring during the charging.

Another method is utilizing the time sharing principle, which makes extra currents flow into the storage battery having a lower voltage by means of the control and switching of a switch component, so as to charge the storage battery set uniformly. The charging efficiency of this method is high, but the control of charge is more complicated.

Yet another method is that the storage battery set is controlled by a single chip and each storage battery has a separate module. Each storage battery is charged by its own module according to a predetermined procedure, and is automatically powered off after the charging is completed. This method is simple, but will increase the cost of the system if there are too many storage batteries and is disadvantageous in reducing the size of the system.

### SUMMARY OF THE INVENTION

The present invention provides a charge and discharge balancing circuit for a storage battery set, which can make each storage battery achieve a balanced charge and discharge by a simple control of a switch set and the charge and discharge between the storage battery and the electricity storage component, thereby extending the cycle life of the storage battery set.

In a first aspect, the present invention provides a charge and discharge balancing circuit for a storage battery set, the storage battery set connected in parallel to a load and constituted of n storage batteries connected in series where n is an integer of 2 or above, the circuit comprising:
a switch set constituted of n switches, each switch having a first switching node, a second switching node and a common node, the second switching node of a previous switch and the first switching node of a next switch being electrically connected, and the first switching node and the second switching node of each switch being connected in parallel to both terminals of the storage battery in order;
an electricity storage component set constituted of n−1 electricity storage components connected in series, both terminals of each electricity storage component being connected in parallel to the common nodes of two switches in order; and
a pulse generator for controlling the switching of the common node of each switch between the first switching node and the second switching node at a frequency.

In a second aspect, the present invention provides a charge and discharge balancing circuit for a storage battery set, the storage battery set connected in parallel to a load and constituted of n storage batteries connected in series where n is an integer of 3 or above, the circuit comprising:
a switch set constituted of n switches, each switch having a first switching node, a second switching node and a common node, the second switching node of a previous switch and the first switching node of a next switch being electrically connected, and the first switching node and the second switching node of each switch being connected in parallel to both terminals of the storage battery in order;
an electricity storage component set constituted of n−1 electricity storage components connected in series, both terminals of each electricity storage component being connected in parallel to the common nodes of two switches in order;
at least one parallel switch set constituted of m switches where m is larger than or equal to 2 and is smaller than n, the second switching node of a previous switch and the first switching node of a next switch being electrically connected, and the first switching node and the second switching node of each switch being connected in parallel to at least two electricity storage components in order;
at least one parallel electricity storage component set constituted of m−1 electricity storage components connected in series, both terminals of each electricity storage component of the at least one parallel electricity storage component set being connected in parallel to the common nodes of two switches of the at least one parallel switch set in order; and
a pulse generator for controlling the switching of the common node of each switch between the first switching node and the second switching node at a first frequency, and for controlling the switching of the common node of each switch of the at least one parallel switch set between the first switching node and the second switching node at a second frequency.

In the charge and discharge balancing circuit for a storage battery set according to the first or second aspect, the electricity storage component is one of a capacitor and a supercapacitor.

In the charge and discharge balancing circuit for a storage battery set according to the first aspect, the frequency of the pulse generator for controlling each switch depends on the condition that the charging and discharging voltages of each storage battery and electricity storage component connected in parallel are the same.

In the charge and discharge balancing circuit for a storage battery set according to the second aspect, the first frequency of the pulse generator for controlling each switch depends on the condition that the charging and discharging voltages of each storage battery and electricity storage component connected in parallel are the same, the second frequency of the pulse generator for controlling each switch depends on the condition that the charging and discharging voltages of at least two electricity storage components of the electricity storage component set and at least two electricity storage components of the at least one parallel electricity storage component set are the same, and the pulse generator divides the first frequency to obtain the second frequency.

### BRIEF DESCRIPTION OF THE DRAWINGS

FIG. 1 is a circuit diagram of a charge and discharge balancing circuit for a storage battery set according to a first embodiment of the present invention.

FIG. 2 is a circuit diagram of a charge and discharge balancing circuit for a storage battery set according to a second embodiment of the present invention.

### DESCRIPTION OF PREFERRED EMBODIMENTS

Several preferred embodiments according to the present invention will be described below with reference to the accompanying drawings.

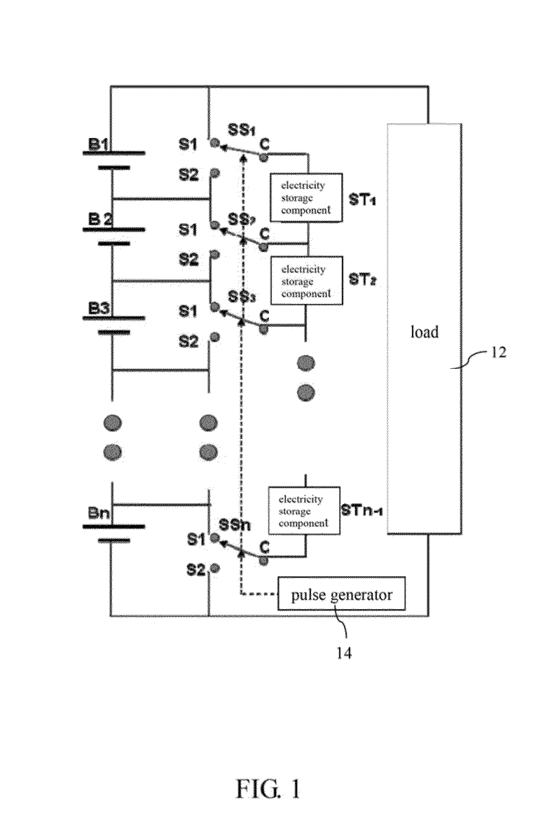

FIG. 1 is a circuit diagram of a charge and discharge balancing circuit for a storage battery set according to a first embodiment of the present invention. In the circuit of FIG. 1, n storage batteries B₁, B₂, B₃, . . . Bₙ are connected in series (where n is an integer of 2 or above) so as to constitute a storage battery set. The storage battery set is connected in parallel to a load 12, and the storage battery set supplies power to the load 12.

Each of n switches SS₁, SS₂, SS₃, . . . SSₙ has a switching node S₁, a switching node S₂ and a common node C. The switching node S₂ of the first switch SS₁ and the switching node S₁ of the second switch SS₂ are electrically connected; the switching node S₂ of the second switch SS₂ and the switching node S₁ of the third switch SS₃ are electrically connected; the switching node S₂ of the n−1th switch SSₙ₋₁ and the switching node S₁ of the nth switch SSₙ are electrically connected; and so on. These n switches SS₁, SS₂, SS₃, . . . SSₙ are connected in series to constitute a switch set.

The switching node S₁ and the switching node S₂ of the first switch SS₁ are connected in parallel to both terminals of the storage battery B₁; the switching node S₁ and the switching node S₂ of the second switch SS₂ are connected in parallel to both terminals of the storage battery B₂; the switching node S₁ and the switching node S₂ of the nth switch SSₙ are connected in parallel to both terminals of the storage battery Bₙ; and so on.

An electricity storage component set is constituted of n−1 electricity storage components ST₁, ST₂, . . . STₙ₋₁ connected in series. Both terminals of the electricity storage component ST₁ are connected in parallel to the common nodes C of the two switches SS₁, SS₂; both terminals of the electricity storage component ST₂ are connected in parallel to the common nodes C of the two switches SS₂, SS₃; both terminals of the electricity storage component STₙ₋₁ are connected in parallel to the common nodes C of the two switches SSₙ₋₁ (not shown), SSₙ; and so on. The electricity storage component ST₁, ST₂, . . . STₙ₋₁ is a capacitor or a supercapacitor.

A pulse generator 14 controls the switching of the common node C of each switch SS₁, SS₂, SS₃, . . . SSₙ between the switching node S₁ and the switching node S₂ at a frequency. The frequency of the pulse generator 14 for controlling each switch SS₁, SS₂, SS₃, . . . SSₙ depends on the condition that the charging and discharging voltages of each storage battery B₁, B₂, B₃, . . . Bₙ and electricity storage component ST₁, ST₂, . . . STₙ₋₁ connected in parallel are the same.

When the storage battery set (namely, the storage batteries B₁, B₂, B₃, . . . Bₙ connected in series) supplies power to the load 12, the pulse generator 14 controls the conduction of the common node C of each switch SS₁, SS₂, SS₃, . . . SSₙ and the switching node S₁ at, for example, the positive cycle of a frequency, so that the storage battery B₁ is connected in parallel to the electricity storage component ST₁ through the common nodes C of the switches SS₁, SS₂ and the switching nodes S₁, the storage battery B₂ is connected in parallel to the electricity storage component ST₂ through the common nodes C of the switches SS₂, SS₃ and the switching nodes S₁, the storage battery Bₙ₋₁ is connected in parallel to the electricity storage component STₙ₋₁ through the common nodes C of the switches SSₙ₋₁ (not shown), SSₙ and the switching nodes S₁, and so on; the pulse generator 14 controls the conduction of the common node C of each switch SS₁, SS₂, SS₃, . . . SSₙ and the switching node S₂ at the negative cycle of a frequency, so that the storage battery B₂ is connected in parallel to the electricity storage component ST₁ through the common nodes C of the switches SS₁, SS₂ and the switching nodes S₂, the storage battery B₃ is connected in parallel to the electricity storage component ST₂ through the common nodes C of the switches SS₂, SS₃ and the switching nodes S₂, the storage battery Bₙ is connected in parallel to the electricity storage component STₙ₋₁ through the common nodes C of the switches SSₙ₋₁ (not shown), SSₙ and the switching nodes S₂, and so on.

Between the storage battery and the electricity storage component that are connected in parallel, the one having a higher voltage charges the other having a lower voltage, and inversely the latter discharges the former. For example, in the positive cycle of the first cycle, the storage battery B₁ is connected in parallel to the electricity storage component ST₁, and the storage battery B₁ charges the electricity storage component ST₁ so that the voltage of the electricity storage component ST₁ equals to the voltage of the storage battery B₁.

In the negative cycle of the first cycle, the storage battery B₂ is connected in parallel to the electricity storage component ST₁, and if the voltage of the storage battery B₂ is higher than that of the electricity storage component ST₁, the storage battery B₂ charges the electricity storage component ST₁ so that the voltage of the electricity storage component ST₁ equals to the voltage of the storage battery B₂.

In the positive cycle of the second cycle, the storage battery B₁ is again connected in parallel to the electricity storage component ST₁, and because the voltage of the storage battery B₁ is lower than that of the electricity storage component ST₁, the electricity storage component ST₁ discharges to the storage battery B₁ so that the voltage of the electricity storage component ST₁ equals to the voltage of the storage battery B₁.

In the negative cycle of the second cycle, the storage battery B₂ is connected in parallel to the electricity storage component ST₁, and because the voltage of the storage battery B₂ is higher than that of the electricity storage component ST₁, the storage battery B₂ charges the electricity storage component ST₁ again so that the voltage of the electricity storage component ST₁ equals to the voltage of the storage battery B₂.

As described above, the pulse generator 14 controls the switching of each switch SS₁, SS₂, SS₃, . . . SSₙ, and the electricity storage components ST₁, ST₂, . . . STₙ₋₁ charge and discharge the adjacent storage batteries B₁, B₂, B₃, . . . Bₙ. By means of the charge and discharge of energy until the voltage of each of the storage batteries B₁, B₂, B₃, . . . Bₙ that are connected in series reaches consistency, the problem of unbalanced voltage between each of the storage batteries can be improved.

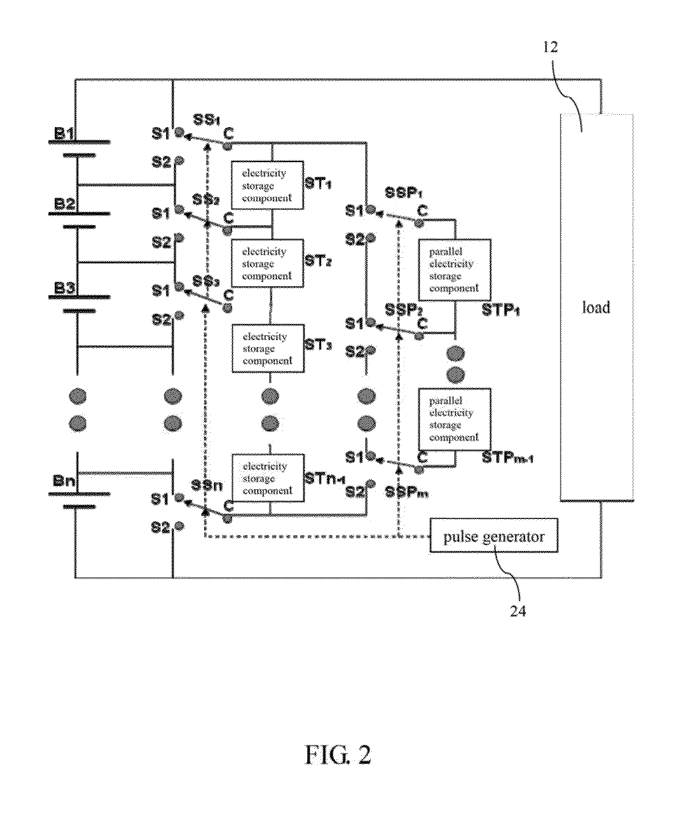

FIG. 2 is a circuit diagram of a charge and discharge balancing circuit for a storage battery set according to a second embodiment of the present invention. The reference numerals for the components in the circuit of FIG. 2 that are the same as those in the circuit of FIG. 1 represent the same components, and the description of their structure and operation are omitted. In FIG. 2, a first frequency of the pulse generator 24 for controlling each switch SS₁, SS₂, SS₃, . . . SSₙ depends on the condition that the charging and discharging voltages of each storage battery B₁, B₂, B₃, . . . Bₙ and electricity storage component ST₁, ST₂, . . . STₙ₋₁ connected in parallel are the same, where n is greater than or equal to 3.

Each of m parallel switches SSP₁, SSP₂, . . . SSPₘ has a switching node S₁, a switching node S₂ and a common node C. The switching node S₂ of the first parallel switch SSP₁ and the switching node S₁ of the second parallel switch SSP₂ are electrically connected; the switching node S₂ of the m−1th parallel switch SSPₘ₋₁ (not shown) and the switching node S₁ of the mth parallel switch SSPₘ are electrically connected; and so on. These m parallel switches SSP₁, SSP₂, . . . SSPₘ are connected in series to constitute a parallel switch set.

The switching node S₁ and switching node S₂ of the first parallel switch SSP₁ are connected in parallel to the two electricity storage components ST₁, ST₂ that are connected in series, the switching node S₁ and switching node S₂ of the second parallel switch SSP₂ are connected in parallel to the two electricity storage components ST₃, ST₄ (not shown) that are connected in series, and so on. In another embodiment, the switching node S₁ and switching node S₂ of each parallel switch can be connected in parallel to more than two electricity storage components that are connected in series.

A parallel electricity storage component set is constituted of m−1 parallel electricity storage components STP₁, . . . STPₘ₋₁ connected in series. Both terminals of the parallel electricity storage component STP₁ are connected in parallel to the common nodes C of the two parallel switches SSP₁, SSP₂, both terminals of the parallel electricity storage component STPₘ₋₁ are connected in parallel to the common nodes C of the two parallel switches SSPₘ₋₁ (not shown), SSPₘ, and so on. The parallel electricity storage component STP₁, . . . STPₘ₋₁ is a capacitor or a supercapacitor.

The pulse generator 24 controls the switching of the common node C of each parallel switch SSP₁, SSP₂, . . . SSPₘ between the switching node S₁ and the switching node S₂ at a second frequency. The second frequency of the pulse generator 24 for controlling each parallel switch SSP₁, SSP₂, . . . SSPₘ depends on the condition that the charging and discharging voltages of the two electricity storage components ST₁, ST₂ that are connected in parallel and the parallel electricity storage component STP₁ are the same. The others can be deduced by analog and the description thereof is omitted. The first frequency of the pulse generator 24 is an integral multiple of the second frequency, and the pulse generator 24 divides the first frequency so as to obtain the second frequency.

For example, the pulse generator 24 controls the conduction of the common node C of each parallel switch SSP₁, SSP₂, . . . SSPₘ and the switching node S₁ at the positive cycle of the second frequency, so that the two electricity storage components ST₁, ST₂ are connected in parallel to the parallel electricity storage component STP₁ through the common nodes C of the parallel switches SSP₁, SSP₂ and the switching nodes S₁. The others can be deduced by analog and the description thereof is omitted.

The pulse generator 24 controls the conduction of the common node C of each parallel switch SSP₁, SSP₂, . . . SSPₘ and the switching node S₂ at the negative cycle of the second frequency, so that the two electricity storage components ST₃, ST₄ (not shown) are connected in parallel to the parallel electricity storage component STP₁ through the common nodes C of the parallel switches SSP₁, SSP₂ and the switching nodes S₂. The others can be deduced by analog and the description thereof is omitted.

Between the two serially-connected electricity storage components and the parallel electricity storage component that are connected in parallel, the one having a higher voltage charges the other having a lower voltage, and inversely the latter discharges the former.

For example, in the positive cycle of the first cycle, the two serially-connected electricity storage components ST₁, ST₂ are connected in parallel to the parallel electricity storage component STP₁, and the two serially-connected electricity storage components ST₁, ST₂ charge the parallel electricity storage component STP₁ so that the voltage of the parallel electricity storage component STP₁ equals to the voltage of the two serially-connected electricity storage components ST₁, ST₂.

In the negative cycle of the first cycle, the two serially-connected electricity storage components ST₃, ST₄ (not shown) are connected in parallel to the parallel electricity storage component STP₁, and if the voltage of the two serially-connected electricity storage components ST₃, ST₄ (not shown) is higher than that of the parallel electricity storage component STP₁, the two serially-connected electricity storage components ST₃, ST₄ (not shown) charge the parallel electricity storage component STP₁ so that the voltage of the parallel electricity storage component STP₁ equals to the voltage of the two serially-connected electricity storage components ST₃, ST₄ (not shown).

In the positive cycle of the second cycle, the two serially-connected electricity storage components ST₁, ST₂ are again connected in parallel to the parallel electricity storage component STP₁, and because the voltage of the two serially-connected electricity storage components ST₁, ST₂ is lower than that of the parallel electricity storage component STP₁, the parallel electricity storage component STP₁ discharges to the two serially-connected electricity storage components ST₁, ST₂ so that the voltage of the parallel electricity storage component STP₁ equals to the voltage of the two serially-connected electricity storage components ST₁, ST₂.

In the negative cycle of the second cycle, the two serially-connected electricity storage components ST₃, ST₄ (not shown) are again connected in parallel to the parallel electricity storage component STP₁, and because the voltage of the two serially-connected electricity storage components ST₃, ST₄ (not shown) is higher than that of the parallel electricity storage component STP₁, the two serially-connected electricity storage components ST₃, ST₄ (not shown) charge the parallel electricity storage component STP₁ again so that the voltage of the parallel electricity storage component STP₁ equals to the voltage of the two serially-connected electricity storage components ST₃, ST₄ (not shown).

As described above, the pulse generator 24 controls the switching of each switch SS₁, SS₂, SS₃, . . . SSₙ and parallel switch SSP₁, SSP₂, . . . SSPₘ, and the electricity storage components ST₁, ST₂, . . . STₙ₋₁ charge and discharge the adjacent storage batteries B₁, B₂, B₃, . . . Bₙ, and the parallel electricity storage components STP₁, . . . STPₘ₋₁ charge and discharge the adjacent two serially-connected electricity storage components ST₁, ST₂, . . . STₙ₋₁. For a larger amount of the storage batteries B₁, B₂, B₃, . . . Bₙ, it takes a longer time to make the voltage of each storage battery B₁, B₂, B₃, . . . Bₙ to reach consistency merely by the switch set (namely, the switches SS₁, SS₂, SS₃, . . . SSₙ) and the electricity storage component set (namely, the electricity storage components ST₁, ST₂, . . . STₙ₋₁); however, with the parallel switch set (namely, the parallel switches SSP₁, SSP₂, . . . SSPₘ) and the parallel electricity storage component set (namely, the parallel electricity storage components STP₁, . . . STPₘ₋₁) added into the charge and discharge balancing circuit, the further charge and discharge of energy will shorten the time that the voltage of each of the serially-connected storage batteries B₁, B₂, B₃, . . . Bₙ reaches consistency, and the problem of unbalanced voltage between each of the storage batteries can be improved.

In another embodiment where the amount of the serially-connected storage batteries is increased, the amounts of parallel connections between the parallel switch sets and the parallel electricity storage component sets in the charge and discharge balancing circuit can be increased; namely, the first parallel switch set is connected in parallel to the electricity storage component set, the first parallel electricity storage component set is connected in parallel to the first parallel switch set, the second parallel switch set is connected in parallel to the first parallel electricity storage component set, the second parallel electricity storage component set is connected in parallel to the second parallel switch set, and so on. Thus the time that the voltage of each of the serially-connected storage batteries reaches consistency can be further shortened.

The present invention is advantageous in providing a charge and discharge balancing circuit for a storage battery set, which can make each storage battery achieve a balanced charge and discharge by a simple control of a switch set and the charge and discharge between the storage battery and the electricity storage component, thereby extending the cycle life of the storage battery set.

While the present invention has been described above with reference to the preferred embodiments and illustrative drawings, it should not be considered as limited thereby. Various equivalent alterations, omissions and modifications made to its configuration and the embodiments by the skilled persons could be conceived of without departing from the scope of the present invention.

### REFERENCE NUMERALS

12 load
14 pulse generator
24 pulse generator
B₁, B₂, B₃, . . . Bₙ storage battery
SS₁, SS₂, SS₃, . . . SSₙ switch
SSP₁, SSP₂, SSP₃, . . . SSPₘ parallel switch
ST₁, ST₂, ST₃, . . . STₙ₋₁ electricity storage component
STP₁, SSP₂, STP₃, . . . STPₘ₋₁ parallel electricity storage component

What is claimed is:

1. A charge and discharge balancing circuit for a storage battery set, the storage battery set connected in parallel to a load and constituted of n storage batteries connected in series where n is an integer of 2 or above, the circuit comprising:
a switch set constituted of n switches, each switch having a first switching node, a second switching node and a common node, the second switching node of a previous switch and the first switching node of a next switch being electrically connected, and the first switching node and the second switching node of each switch being connected in parallel to both terminals of the storage battery in order;
an electricity storage component set constituted of n−1 electricity storage components connected in series, both terminals of each electricity storage component being connected in parallel to the common nodes of two switches in order; and
a pulse generator for controlling the switching of the common node of each switch between the first switching node and the second switching node at a frequency.

2. A charge and discharge balancing circuit for a storage battery set, the storage battery set connected in parallel to a load and constituted of n storage batteries connected in series where n is an integer of 3 or above, the circuit comprising:
a switch set constituted of n switches, each switch having a first switching node, a second switching node and a common node, the second switching node of a previous switch and the first switching node of a next switch being electrically connected, and the first switching node and the second switching node of each switch being connected in parallel to both terminals of the storage battery in order;
an electricity storage component set constituted of n−1 electricity storage components connected in series, both terminals of each electricity storage component being connected in parallel to the common nodes of two switches in order;
at least one parallel switch set constituted of m switches where m is larger than or equal to 2 and is smaller than n, the second switching node of a previous switch and the first switching node of a next switch being electrically connected, and the first switching node and the second switching node of each switch being connected in parallel to at least two electricity storage components in order;
at least one parallel electricity storage component set constituted of m−1 electricity storage components connected in series, both terminals of each electricity storage component of the at least one parallel electricity storage component set being connected in parallel to the common nodes of two switches of the at least one parallel switch set in order; and
a pulse generator for controlling the switching of the common node of each switch between the first switching node and the second switching node at a first frequency, and for controlling the switching of the common node of each switch of the at least one parallel switch set between the first switching node and the second switching node at a second frequency.

3. The circuit according to claim 1, wherein the electricity storage component is one of a capacitor and a supercapacitor.

4. The circuit according to claim 1, wherein the frequency of the pulse generator for controlling each switch depends on the condition that the charging and discharging voltages of each storage battery and electricity storage component connected in parallel are the same.

5. The circuit according to claim 2, wherein the first frequency of the pulse generator for controlling each switch depends on the condition that the charging and discharging voltages of each storage battery and electricity storage component connected in parallel are the same, the second frequency of the pulse generator for controlling each switch depends on the condition that the charging and discharging voltages of at least two electricity storage components of the electricity storage component set and the electricity storage component of the at least one parallel electricity storage component set are the same, and the pulse generator divides the first frequency to obtain the second frequency.

6. The circuit according to claim 2, wherein the electricity storage component is one of a capacitor and a supercapacitor.
